(19) United States
(12) Patent Application Publication
(10) Pub. No.: US 2020/0184400 A1
(43) Pub. Date: Jun. 11, 2020

(54) PROBABILISTIC BASED SYSTEM AND METHOD FOR DECISION MAKING IN THE CONTEXT OF ARGUMENTATIVE STRUCTURES

(71) Applicant: GROUPE DE DEVELOPPEMENT ICRTECH, Laval, Quebec (CA)

(72) Inventors: Hans Bherer, Montreal, Quebec (CA); Idriss Elmegzari, Montreal, Quebec (CA)

(21) Appl. No.: 16/609,106

(22) PCT Filed: Apr. 30, 2018
(86) PCT No.: PCT/CA2018/050507

§ 371 Date: Oct. 28, 2019

Related U.S. Application Data
(60) Provisional application No. 62/491,849, filed on Apr. 28, 2017.

(51) Int. Cl. G06Q 10/06; G06Q 30/00; G06N 7/00; G06N 5/00; G06N 20/20

(52) U.S. Cl. CPC G06Q 10/06375; G06Q 30/018; G06N 20/20; G06N 5/003; G06N 7/005

(57) ABSTRACT

A probabilistic based system and method for decision making in the context of argumentative structures is described. This method and system use methods of calculations of the probabilities of success of using the evaluated argumentative structure to achieve one or more goal. The methods generally aims at maximizing the probability of achieving stated goals in optimal compliance of specified laws, regulations, norms and standards, within a practical real case environment.

### CROSS-REFERENCE TO RELATED APPLICATIONS

The present patent application claims the benefits of priority of commonly assigned U.S. Patent Application No. 62/491,849, entitled “Probabilistic based system and method for decision making in the context of argumentative structures” and filed at the United States Patent and Trademark Office on Apr. 28, 2017.

### FIELD OF THE INVENTION

The present invention generally relates to the field of systems and methods of decision making using argumentative structure and more particularly to the field of systems and methods for evaluating and interpreting argumentative structures, typically in the field of compliance, audit and argumentative structures of evaluation.

### BACKGROUND OF THE INVENTION

Today, more and more enterprises are faced with conformity and compliance requirements, for example to different laws, norms and standards such as the ISO standard. The argumentative approach in building an audit or compliance framework typically requires a methodology allowing the construction of an evaluation structure based on the adaptive analysis of experts of the said laws, norms and standards to which an enterprise wishes to conform to. Though many methodologies exist (some based on the descriptive structure languages of GSN or TCL for example) to facilitate the construction of an argumentative structure, it is believed that such methodologies may be improved in order to produce a methodology that is customized and that can accurately adapt to and interpret different standards, laws and norms as well as adapt to practical conditions in a company environment. One of the drawbacks of argumentative structures is in the general lack of quantitative evaluations having a sufficient level of confidence with regard to monitoring the progress of enterprises in how different top goals are achieved and how the strategies leading up to these under compliance conditions are established. There is thus a need for a method for interpretation of an evaluated argument structure having a level of complexity no less than the level of complexity of a method for evaluation of the argument.

Also, a methodology for adapting of the argumentative approach to the field of compliance by constructing adaptive argumentative structures of evaluation is thus needed. Such method or system should aim at providing a quantitative assessment of the level of compliance to laws, norms or standards while providing theoretical and projected practical probabilities of success for reaching specified goals. Such method should also aims at establishing a structure able to adapt to the various positions taken by all parties concerned. In other words, the argumentative structure shall aim at being constructed and being evaluated according to different expert opinions to reflect the practical realities of an active environment within the enterprise. There is thus a need for a method aiming at ensuring an accurate assessment of how to reach a maximum of success probability while achieving the stated goals.

### SUMMARY OF THE INVENTION

The shortcomings of the prior art are generally mitigated by adding to each element of an argument structure, an opinion vector or an opinion space. The opinion space is used to evaluate the argument structure. The argument structure may later be interpreted through the use of a Beta distribution typically obtained by mapping the opinion space to an interpretation space. The argument structure is constructed by mathematically interpreting aggregation rules. The aggregation rules are used to define to explicit the different links between the evidences and the claims supported by such evidences.

In one aspect of the invention, the argument structure may be visualized as a tree composed of argument nodes branching off from one another, leading up to a main goal required to be achieved under compliance conditions. Quantitative values are generally assigned to each element of the argument structure or argument nodes, such that a final quantitative value is extracted, being an interval in which the probability of success for achieving the specified top goal lies. The said interval should comprise an optimal compliance to target laws, norms or standards in mind. In other words, the mathematical model of the Beta distributions along with aggregation rules, such as but not limited to Dempster-Shafer, Yager or Josang, are used to support the structure and to allow for probabilities of success to be calculated along the entire structure. Each argument node is associated with an opinion vector or an opinion space. The opinion vector assigns values of belief, disbelief and uncertainty from the perspective of experts, the whole of which promotes conformity. Understandably, the structure for evaluation herein described may therefore be easily changed and adapted to other conditions over time, having been quantitatively assessed in its construction.

The method herein disclosed for constructing an argumentative structure of evaluation comprises steps to theoretically analyze and determine the desired standard with which the construction of the theoretical argumentative structure is to represent. The structure is generally organized or displayed as a tree structure largely composed of at least one top goal, branching down to at least one strategy. The strategy branches off to secondary goals, where each secondary goal branches off to an associated proof at the base of the tree. Therefore, as an example, from the bottom up, the argumentative structure is constructed as two elements of proof at the base of the structure, each proof supporting a secondary goal, a strategy that is formulated based on the secondary goals and finally a main top goal that is reached if the strategy is properly applied. Once this argumentative structure is constructed, the second step in the method is to consult with experts on the desired strategies, secondary goals and proofs to reach in question, to determine whether any other arguments are required to complete the construction of the final theoretical argumentative structure. The third step is to choose the statistical aggregation rule(s) that are required to assign values to each argument element in the tree structure and that allow one to calculate probabilities of success, thereby completing the theoretical argumentative structure according to a quantitative assessment. An example of an aggregation rule is the rule of equivalence. The fourth step in the method is to validate the quantitative structure with the experts and to modify the structure if necessary according to their feedback. The fifth step is to evaluate the final theoretical argumentative structure to arrive at a final evaluation value or probability of success of the main goal at the top of the structure. Generally stated, a belief measure is used.

As an example, if two experts contributed to the construction of a final structure, each may evaluate the support of the two proofs at the base of the final structure leading up to the top goal by way of the determined strategy and secondary goals, with a maximum in a theoretically evaluated belief measure of 1. The belief measure is represented as one component of the opinion vector, such as (belief, disbelief, uncertainty). The belief, disbelief and uncertainty values are generally denoted by the letters “b”, “d” and “u” and respectively forms an opinion vector for each concerned party and assigned to each argument node.

An atomicity value, being a weighting value, herein exemplified by the letter ‘a’ for the main top goal, may be added to the belief measure. In such case, the atomicity is added to the opinion vector, resulting in a vector as follow: (belief, disbelief, uncertainty, atomicity). In a typical embodiment, two experts provide different evaluations or provide different opinions as a measure of the quality of each proof, or whether a strategy would have been sufficiently proven to have been applied, as these relate to the achievement of the desired top goal and as part of the argumentative structure constructed to comply with certain laws, norms and/or standards. In a binary frame of discernment, the atomicity of an atomic state is ½.

In event where a proof has been confirmed to exist within the enterprise, the belief value is ‘1’ as the percentage of belief is 100%. At this step, the structure was evaluated by the two experts, the two experts having considered practical assessments. Such evaluation is considered as being a Gold standard or reference standard.

The method further comprises evaluating the structure in a real case as part of the enterprise that wishes to conform to the desired standard. The method further comprises evaluation a combination of the belief measures assigned to each argument node within the context of the practical real case. A probability of success is calculated for the main top goal using a Beta distribution in consideration of the opinion spaces specified in a practical, real case context, and this, throughout the argumentative structure. A quantitative theoretical and a quantitative practical representation of the constructed argument structure of evaluation are thus produced. Once this success probability has also been calculated, the decider may pursue the accreditation, certification, audit or other demand based a the resulting argumentative evaluation structure if the probability of success acceptable to the decider or may alter the argumentative structure to improve the probability of success of the main top goal which may include providing better elements of proof, or better strategies to support the structure.

In another aspect of the invention, a method for decision making in the context of argumentative structures is disclosed. The method comprises setting a Gold standard or reference standard for which a minimum level of success probability is calculated for a reference argumentative structure (typically using a DST-Beta mapping—Gold standard). The method further comprises using an opinion vector associated with a top goal of the argumentative structure to be evaluated to calculate the Beta distribution. The method further comprises calculating the probability that the Esperance associated with the top goal of the argumentative structure to be evaluated is higher than the Esperance of the established Gold standard. If the calculated probability is higher than a predetermined value (generally set by experts having evaluated the nodes of the argumentative structure), the structure or affirmation is realized or satisfied. A decider may then use such information to make a decision based on the context of the affirmation of the top goal and/or of the field of application.

In another aspect of the invention, a computer-implemented method comprising an evaluation argumentative structure to theoretically analyze and determine a desired standard with which a construction of the theoretical argumentative structure is to represent, the method comprising: a) constructing a theoretical argumentative structure; b) organizing the theoretical argumentative structure as a tree structure, the tree structure comprising nodes, the nodes being a selection of at least one top goal, at least one strategy, at least one secondary goal, or at least one associated proof; c) identifying a plurality of inference computational rule between the nodes to finalize the theoretical argumentative structure; d) evaluating the probative value of the proof nodes of the finalized theoretical argumentative structure using an opinion vector to create an evaluated theoretical argumentative structure being the minimum level to be obtained; e) combining the evaluated probative values using a mathematical model of Beta distributions; and f) computing a probability of success of a top goal using all evaluation values of each node to by iteratively using the opinion vector as input to each inference computational rule to obtain a faith level for each node, the faith level of the top goal being the Gold standard.

In another aspect of the invention, the computer-implemented method further comprises obtaining evaluations of the theoretical argumentative structure from at least two experts, wherein the experts are specialized or trained in the compliance of the standard or goal aimed to be achieved by the theoretical argumentative structure. The method further comprising modifying the theoretical argumentative structure based on the obtained evaluations.

In another aspect of the invention, the computer-implemented method further comprising: a) providing a comparable argumentative structure similar in structure to the theoretical argumentative structure; b) evaluating the proof nodes of comparable argumentative structure in term of validity of the proof by providing at least one vector of belief for each node; and c) comparing the evaluated comparable argumentative structure against the Gold Standard.

In another aspect of the invention, the computer-implemented method further comprises: a) providing a concrete evaluation of all elements of the comparable argumentative structure to provide a practical argumentative structure; b) propagating of the evaluations and the associated values throughout the nodes of the practical argumentative structure; c) rendering a quantitative evaluation of the top nodes of the practical argumentative structure to calculate a final quantitative evaluation of the top goal; and d) calculating a probability of success using a probabilistic distribution, wherein the probabilistic distribution may be a Beta distribution which may be based on Dempster-Shafer model. The method further comprising the comparable argumentative structure being reviewed by at least one expert to validate and/or modify the comparable argumentative structure.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a schematic flow diagram of an embodiment of a method to evaluate an argumentative structure in accordance with the principles of the present invention.

FIG. 2 is a schematic diagram of an exemplary argumentative structure as a tree of argument nodes.

FIG. 3 is an exemplary table of values resulting from the evaluation by two experts of the argumentative structure of the structure of FIG. 2.

FIG. 4 is a table of values representing a theoretical gold standard for the argument structure of FIG. 2.

FIG. 5 is a graphical view of user interface for entering inputs to render the probability distribution of an exemplary argumentative structure evaluation where a probability of success of the structure of FIG. 2 is calculated.

FIG. 6 is schematic diagram of another exemplary argumentative structure as a tree of argument nodes.

FIG. 7 is a table of values representing the theoretical gold standard for the argument structure in FIG. 6.

FIG. 8 is a table of theoretical and real case values resulting from the argumentative structure evaluation performed on the structure in FIG. 6.

FIG. 9 is a table of values resulting from the argumentative structure evaluation performed on the structure in FIG. 6.

FIG. 10 presents a table of values resulting from the argumentative structure evaluation on the structure in FIG. 6, but with a counter-strategy introduced.

FIG. 11 shows interfaces of a system to evaluate an argumentative structure in accordance with the principles of the present invention.

FIG. 12 is a screenshot of an exemplary interface of argumentative structure designer in accordance with the principles of the present invention.

FIG. 13 is a screenshot of an exemplary interface of the evaluation of a strategy node of the argumentative structure of FIG. 12.

FIG. 14 is a screenshot of an exemplary interface of the definition of the Gold Standard of the argumentative structure of FIG. 12.

FIG. 15 is a screenshot of an exemplary interface of the evaluation of the proof of a strategy node of the argumentative structure of FIG. 12.

FIG. 16 is a screenshot of an exemplary interface of the argumentative structure of FIG. 12 being fully evaluated.

FIG. 17 is a screenshot of an exemplary interface using the evaluated argumentative structure to help in making a decision.

### DETAILED DESCRIPTION OF THE PREFERRED EMBODIMENT

A novel probabilistic based system and method for decision making in the context of argumentative structures will be described hereinafter. Although the invention is described in terms of specific illustrative embodiments, it is to be understood that the embodiments described herein are by way of example only and that the scope of the invention is not intended to be limited thereby.

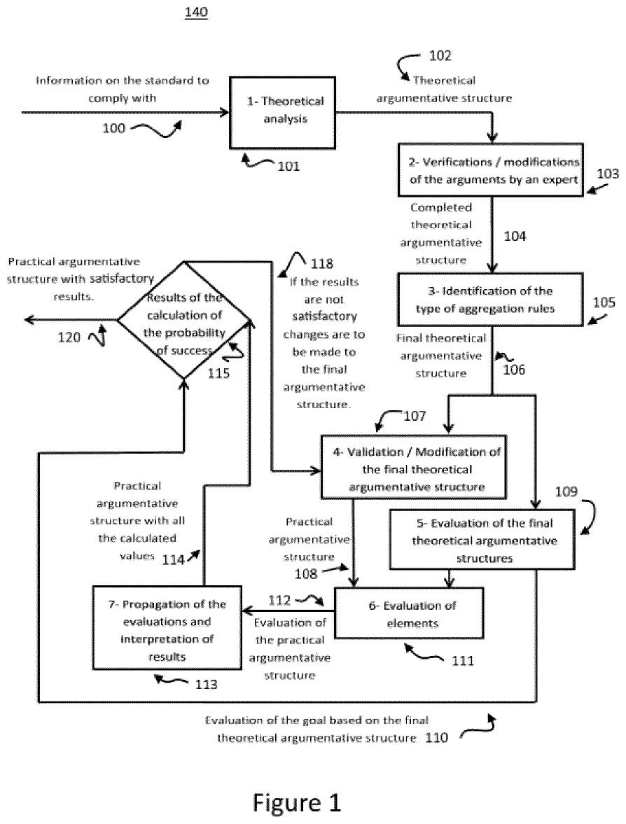

Referring to FIG. 1, a preferred embodiment of method and system for evaluating an argumentative structure 140 is shown. The method 140 may comprise of constructing or creating a model of the argument to be evaluated 101. The construction of the model or structure 101 is based on requirements about a standard to comply with 100.

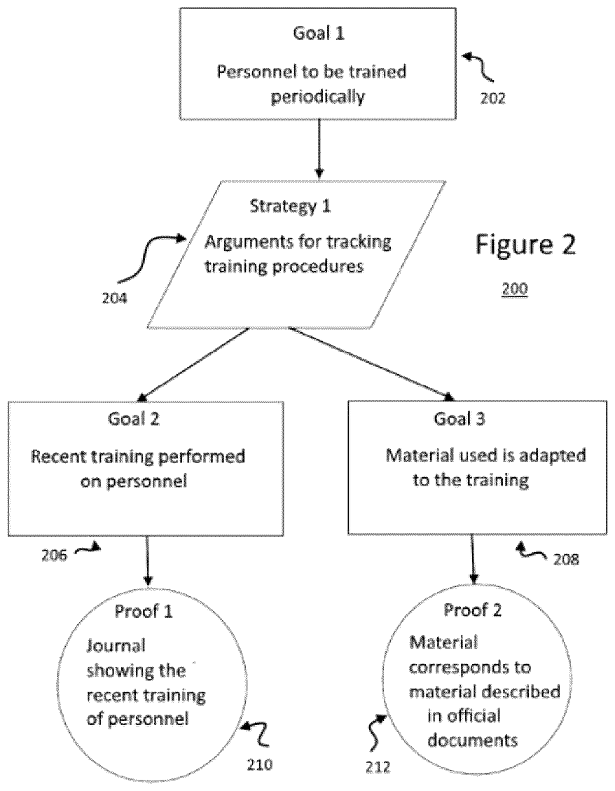

Typically, an example of a structure of an argument 200 based on a modified version of the Goal Structuring Notation (GSN) is shown a FIG. 2. In such a structure 200, different nodes or elements such as goals 202, 206 and 208, strategies 204 and proofs 210, 212 are organized. The nodes of resulting structure 200 are linked with relationships establishing theoretical conditions of fulfillment of said goal 202, 206 and 208 or strategies 204. Even if the present example uses a modified version of the GSN standard, one skilled in the art shall understand that any other standard, codification or modeling language could be used without departing from the concept of the present invention.

Proofs, also known as formal proof, are used to demonstrate that if the strategy or premise is/are true, then the goal(s) is (are) true.

Still referring to FIG. 2, an exemplary structure of an argument aiming at showing that personnel is to be trained periodically 202 (goal) is shown. In such an example, the modeling of the arguments aims at using a strategy for showing arguments while tracking certain training procedures 204. To demonstrate the strategy, further secondary goals are to be reached, which are in this example to confirm recent training performed on personnel 206 and to confirm that the material used is adapted to the training 208. Again, proof for fulfilling the goals must also be linked to the secondary goals 206 and 208. In this example, goal 206 is to be achieved by the existence of a journal showing the recent training of personnel 210 and goal 208 is to be achieved by the existence of material corresponding to the material described in official documents 212.

Referring back to FIG. 1, the created structure 102 may be reviewed by one or more experts to validate and/or modify the said created structure 103. Typically, the one or more experts are specialized in the compliance of the standard or goal aimed to be achieved by the structure 102. As an example, in the exemplary structure of FIG. 2, an expert in an ISO norm including the personnel that is to be trained periodically could be used. Understandably, the reviewing at step 103 may be iterative or executed more than once in order to obtain a complete argumentative structure 106. Thus, upon reviewing, it is most probable that the created structure 102 will be updated or modified in view of the one or more experts' validations and/or modifications' proposals. When the one or more experts do validate the model 102, a complete argumentative structure 106 is obtained.

The nodes of the final argumentative structure 106 comprise inference relationships there between. Rules of inference are templates for building valid arguments. Inference rules must be applied to the relationships to define conditions of achieving the goal(s) 105 by the modeled strategy and proofs. As examples, the inference relationships may be characterized by rules of inference known in the art, such as, but not limited to: addition, simplification, conjunction, resolution, Modus ponens, Modus tollens, hypothetical syllogism, disjunctive syllogism, etc. In the present system, each type of rule is associated with a computation modeled and implemented in the system. The computation model uses a vector of belief as input and outputs the level of faith of such node. Understandably, such computation is typically execute by a device comprising a central processing unit, such as a computer, a server or any other type of computerized device comprising a central processing unit fast enough to execute calculation related to complex structures.

Upon identifying the relationship or inference rules between the nodes 105, the argumentative structure is finalized 106. The method 140 may further comprise a step for the one or more expert to validate and/modify 107 the final argumentative structure 106 having relationship rules. Again, the step of reviewing the final argumentative structure 107 may be iterative as more validation/modifications may be required after each reviewing step 107.

Still referring to FIG. 1, the method further comprises evaluating the probative value of the final theoretical structure 109. The following table shows an exemplary evaluation of the probative value of the proof nodes 210, 212. The one or more experts establish the validity of each proof using a vector of belief, disbelief and uncertainty (b, d, u). The sum of each component of the vector of belief is 1. Each expert may evaluate the quality of the proofs differently.

As an example, the Expert 1 may evaluate a level of belief of 0.75. Belief measures the strength of the evidence in favour of a proposition, in this case, the Expert 1 considers that a journal showing the recent training of personnel 210 (proof) is believed to be evidence of recent training performed on personnel 206 (goal) at a level of 0.75. Disbelief measures the strength of the evidence in favour of the proposition not being true. In this specific example, a disbelief of 0 is used meaning that the presence of a journal showing the recent training of personnel 210 (proof) may not be evidence of not having recent training performed on personnel 206 (goal). The remaining component of the vector, the uncertainty, measures the level of uncertainty of the proposition.

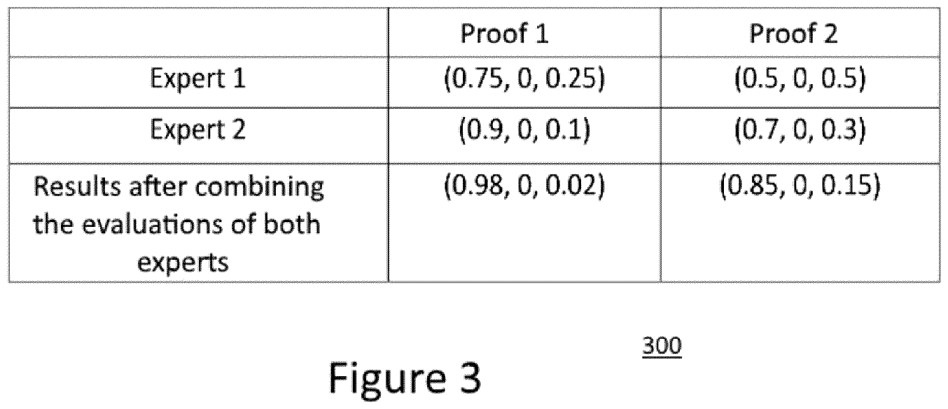

The results of the evaluation on the elements of proof are presented in table 300 by way of example (see FIG. 3).

Referring now to FIG. 3, an exemplary table of evaluations by Expert 1 and Expert 2 is shown. The evaluation of each expert are combined using basic Demster's rule of combination.

Evaluation of each proof nodes are realized and are associated with each node to obtain evaluated argumentative structure (a gold standard). The evaluated argumentative structure providing a hypothetical lower limit characterizing the minimum level of faith that is needed to expect a goal to be successful, such as if the probability of success of an actual goal is higher than the one given by the Gold standard, then a decision can be made. The method further uses all evaluation values of each node to compute a probability of success of the upper goal by iteratively using the belief vector as input to the relationship computation rules to obtain a Faith level for each node. The resulting value of each relationship computation is then input in the next relationship computation rules toward the next node.

The resulting Faith of the main goal is known as the Gold Standard. The Gold Standard is the minimum level of Faith needed to expect that the goal will be fulfilled. In other words, the Gold standard is an argumentative structure itself setting the minimum level of acceptability as to whether or not a given argumentative structure (similar in structure) should be interpreted as a success (Truthness of its goals). In the present example, the Gold Standard is obtained using the following equation:

E(Goal1)=b+au=0.83+0.5×0.17=0.915 (1)
where a=0.5

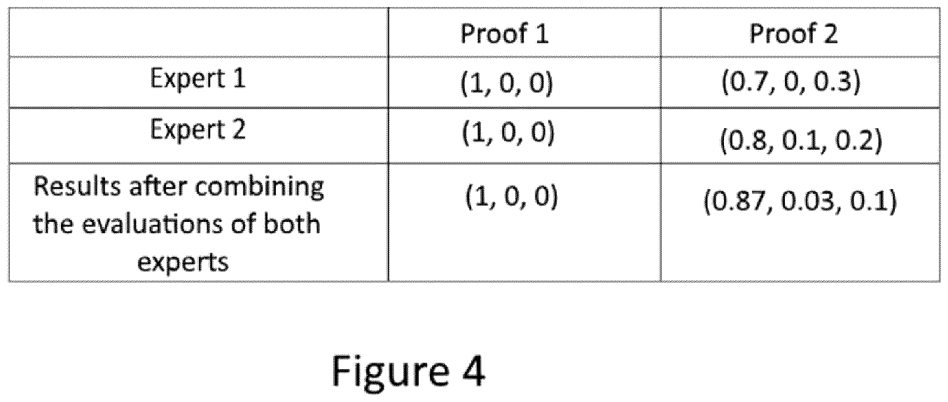

The proof elements are thus evaluated in term of the validity of the proof 111 to compare the structure again the Gold Standard. Again, a vector of belief is associated with the evaluation of the proof. As example, the journal showing the recent training of personnel 210 might have all required information being present, such as date of the training, identification of the personnel member and title of the training session, resulting in a belief vector of (1, 0, 0) (see exemplary table at FIG. 4). However, if some of the records of the journal are missing or are incomplete, the proof may be evaluated as (0.5, 0.2, 0.3).

Now referring to FIG. 4, an exemplary evaluation 109 of two experts of a first proof 210 and a second proof 212 is shown. The combination of the evaluations of Expert 1 and Expert 2 is used to calculate a combined belief vector for each proof. In such an example, the combined value of the belief vector assigned to proof 2 has a value of (0.83, 0, 0.17). Again, by way of example, such a combined value represent a Gold standard with an Faith value denoted as ‘E*’ on the opinion imparted on the goal as part of the constructed argumentative structure, the Faith value is denoted as the following expression with an atomicity ‘a’:

E(Goal1)=b+au=0.83+0.5×0.75=0.915
where a=0.5

The method further comprises providing a concrete evaluation of all elements of the structure to provide a practical argumentative structure 112. The evaluations are propagated 113 throughout the practical structure 112. Propagation of the evaluations and the associated values throughout the structure effectively renders a quantitative evaluation of the root elements of the structure leading up to a final quantitative evaluation of the top goal.

Upon propagation of the evaluation 113, each node of the structure 114 comprises calculated values. A probability of success is calculated as a Beta distribution on the opinion space ‘w’, denoted herein as beta(α,β) for which the equations used to calculate the distribution values are shown below. Understandably, other second order probabilistic distributions could be used without departing from the principles of the present invention. The following equations show an example of calculation of the beta distribution where α and β are functions or formulae of the rules of inference:

$$beta ( α , β ) \\ where \\ α = f ( b , d , u ) \\ β = g ( b , d , u ) \\ \{ \begin{matrix}b = \frac{α - 2 a}{α + β} \\ d = \frac{β - 2 + 2 a}{α + β} \\ u = \frac{2}{( α + β )} \\ a = atomicity\end{matrix} \} ⇔ \{ \begin{matrix}α = 2 ( \frac{b}{u} + a ) \\ β = 2 ( \frac{d}{u} + 1 - a ) \\ b + d + u = 1 \\ a = atomicity\end{matrix} \} \\ {P}_{S} ( w ) = 1 - {\int }_{0}^{E * ( w )} beta ( α , β ) \approx success probability \qquad ( 2 )$$

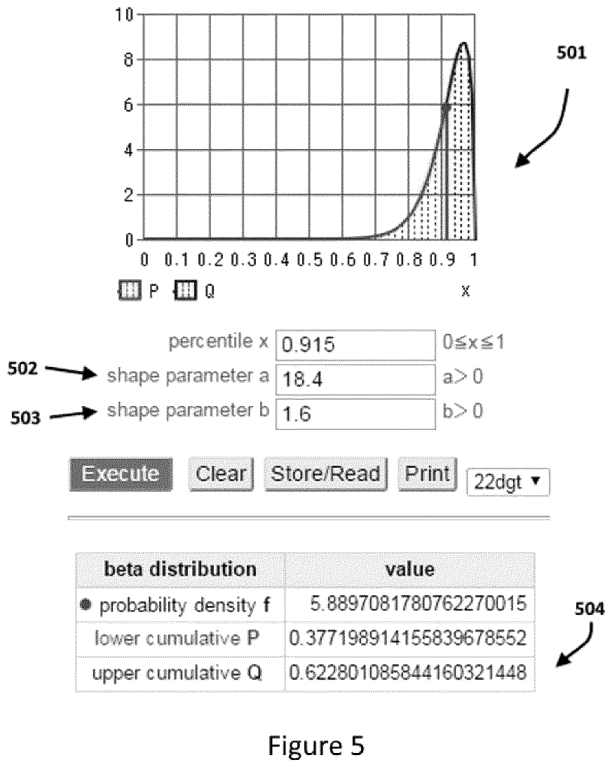

Now referring to FIG. 5, the beta distribution is shown as a graph. As shown in the equation (2), the values of α, β are calculated from the elements of the opinion vector ‘w’ that are belief ‘b’, disbelief ‘d’, uncertainty ‘u’ and of atomicity ‘a’ or vice-versa. In some embodiments, a desired beta distribution (which may be associated with a desired probability of success) may be associated to an opinion vector being introduced or defined in the structure. In the present example, the Goal 1 has a Faith value of E*(w). Opinion space ‘w’ must satisfy the conditions of:

b+d+u=1 and b,d,u,aϵ[0,1]

Still referring to the FIG. 5, the values of the beta distribution of Goal 1 are determined to be beta(18.4, 1.6), which results in a probability of success Ps(Goal 1)≈62.3%. The said probability represents the area under the curb at right of the gold standard value of about 91.5%. This represents the probability of having a faith of at least that which is established by the gold standard when using the argumentative approach modeled in the argumentative structure 114 to reach or obtain the one or more main goals. In the present example, there is only 62.3% of chance of achieving the Goal 1.

As shown in FIG. 5, a graphical user interface for calculating the beta distribution 501 allows a user, such as an expert, to enter values for ‘a’ and ‘b’ 502, 503 respectively for calculating the probability of success 504 for a constructed argumentative structure.

The probability of success aims at validating whether the argumentative approach is strong enough to reach the goal. Thus, upon obtaining the probability of success, the argumentative approach may be implemented if the expected success rate is satisfactory or may be further reviewed or modified 118 using the method 140 to improve the probability of success of having a satisfactory result.

In another embodiment, typically after a first iteration, the method 140 may be adapted to use a modified argumentative structure 110 based on the evaluation of the top goal to calculate new probabilities of success 115. Such an adapted method is typically used when the concrete proof as already been evaluated by the experts 111.

In another embodiment, the construction methodology 140 requires immediate modifications 107 to the final theoretical argumentative structure 106 before rendering a practical argumentative structure 108 that is to be evaluated in its elements 111 (strategies, secondary goals, proofs, etc), evaluated then in its structure 112 and then propagated with interpretations of its results 113 that lead to calculated probabilities of success 115 according to the practical argumentative structure 114. Modifications may be made to introduce different aggregation rules, which may change the argumentative structure itself. These modifications are typically made to render a practical argumentative structure with real world inferences and assumptions being made.

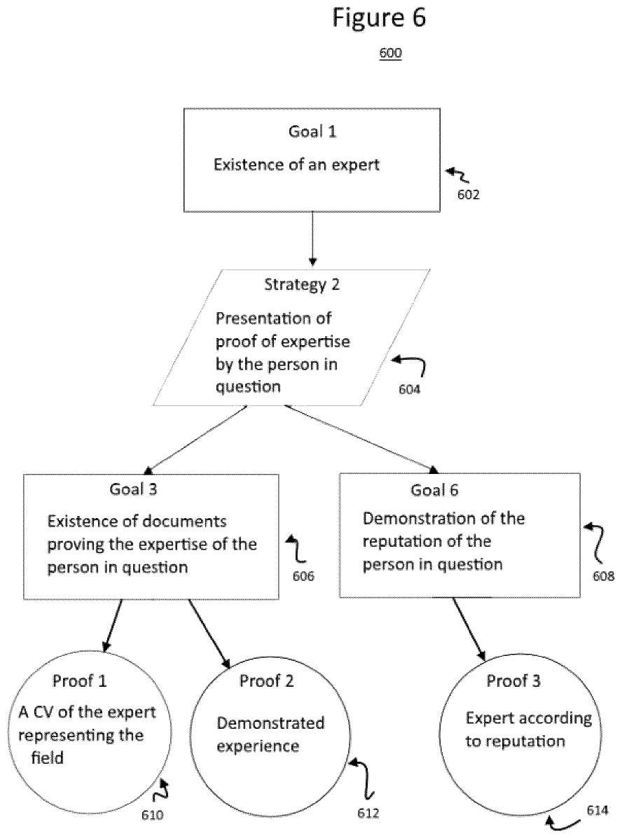

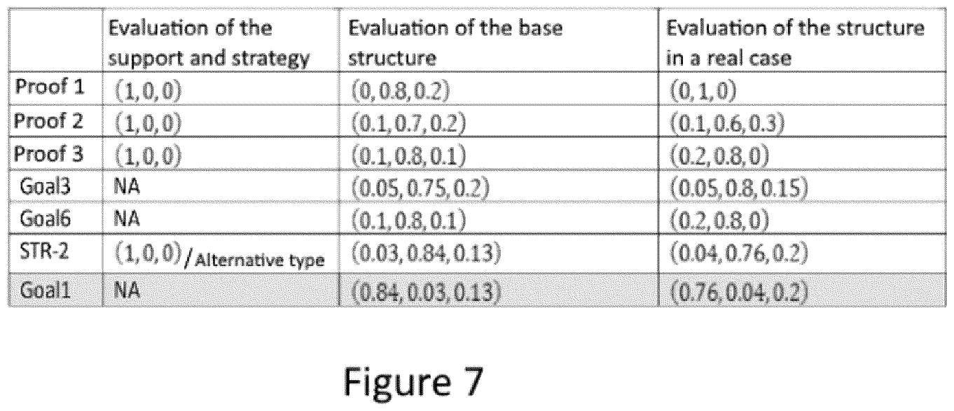

Referring to FIG. 6, the method for comparing opinions and applying a counter-strategy to reach the goal is shown with the theoretical argumentative structure 600 where the main goal, by way of example, is that of bringing in an expert 602. The strategy to verify that an expert exists is to present proof of the expertise of a person in question 604. The secondary goals to achieve this strategy are to provide documents proving the expertise of the person in question 606 and to demonstrate the reputation of the person in question 608. The proof for the existence of the former is composed of the presence of a CV of the expert 610 and proof of demonstrated experience 612. The proof for the existence of the latter is composed of the existence of a proven expert reputation 614. Once the theoretical argumentative structure is confirmed, an identification of the type of aggregation rules needed is made. The values of the theoretical argumentative structure assuming maximum belief in all three elements of proof 608, 610, 612 are shown in FIG. 7. The herein disclosure provides a way to avoid evaluations that are overly optimistic in its quantitative assessment of the prospects of achieving a top goal based on a theoretical, best case scenario. The idea is that an upper bound in an optimal scenario is not based on the theoretical, best case scenario, but on calculations of a faith value that propagate through the entire argumentative structure.

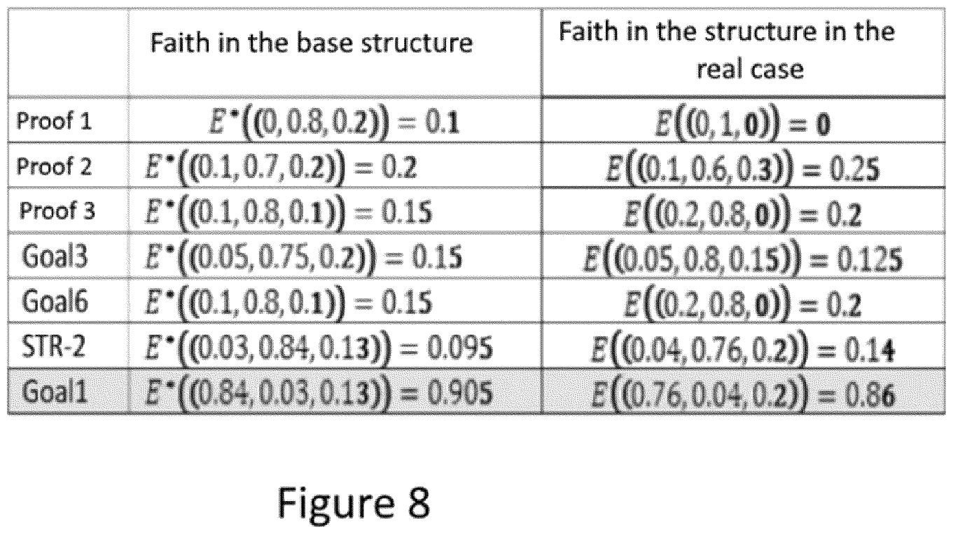

In order to compare the evaluations made by two experts for example, we compute and compare their belief values by using an atomicity ‘a’ equal to ½. For Goal 1 in the structure as part of a theoretical analysis, faith is calculated as E (w)=0.84+0.5×0.13=0.905 and for Goal 1 of the structure in the real, practical case, we calculate the faith as E(w)=0.76+0.5×0.2=0.86. In this case, the evaluation of Goal 1 is to be increased in order to attain an evaluation level that has been determined and put in place by the expert. To do this, the evaluations of the elements under a counter-strategy are to be compared in order to choose and make appropriate changes. Exemplary results are shown in FIG. 8. The task is therefore to change the structure to obtain the optimal results as obtained by the theoretical base structure from the calculations performed in the real, practical case, the result of which becomes a lower case, optimal scenario that needs to be improved on.

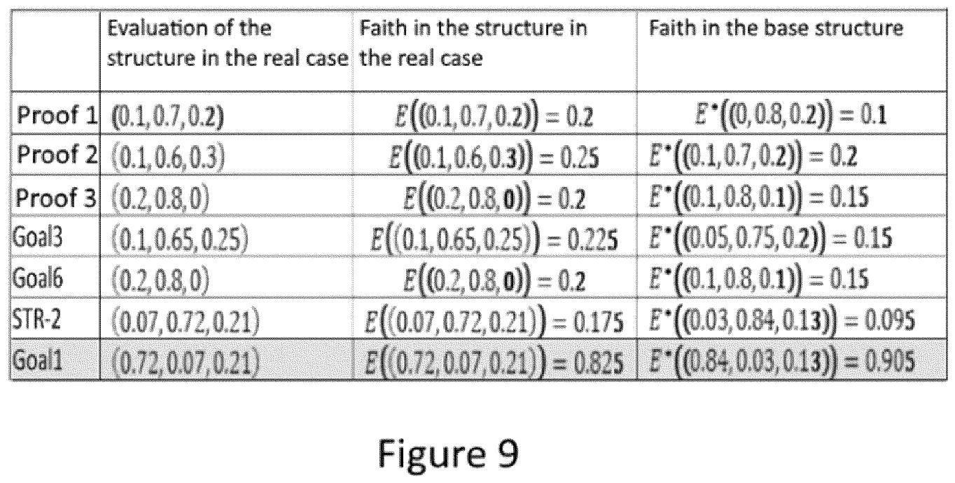

One way of doing this is to increase the evaluation value of Proof 1 to 0.1. Supposing that the evaluation of Proof 1 is increase to (0.1, 0.7, 0.2), this change propagates throughout and the evaluations of the remaining parts of the structure are as shown in FIG. 9.

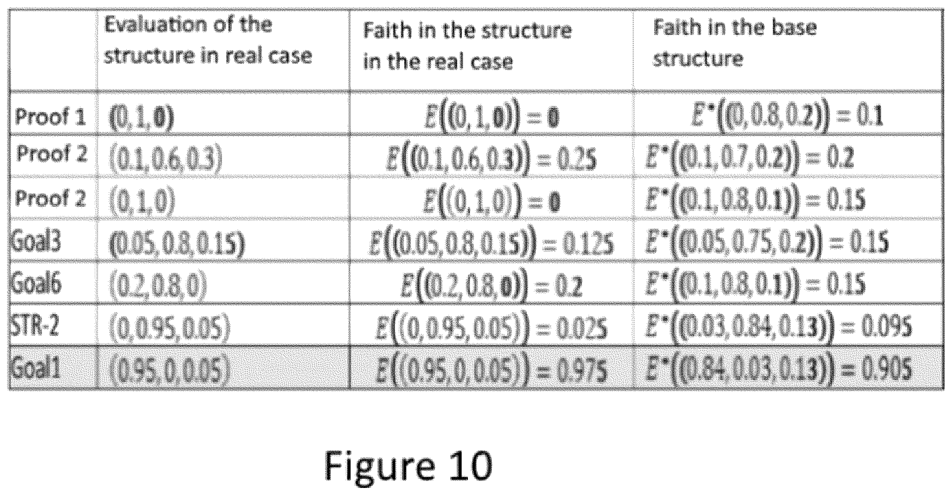

It is therefore important to note that the evaluation of the proofs do not necessarily increase with respect to their base evaluations. In this example, if Proof 3 is changed in such a manner as to diminish its evaluation, the evaluations of the remaining parts of the structure are as shown in FIG. 10. This is an example of the implementation of a counter-strategy, demonstrating a diminishing of evaluations of certain elements of proof that lead to a higher Goal belief value and therefore a more satisfactory argumentative structure of evaluation.

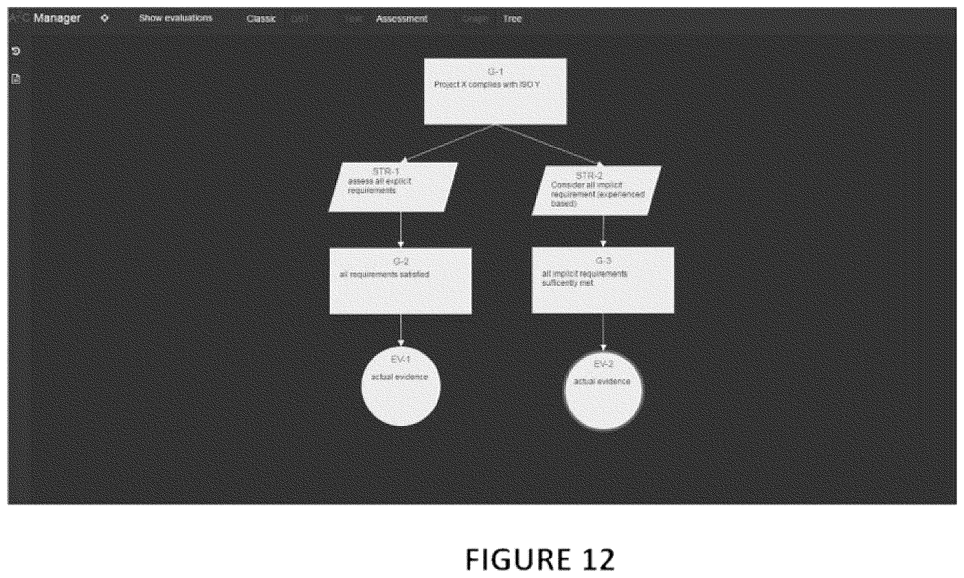

Referring to FIG. 12, exemplary equations used to implement each rule of inference are shown. Each rule of inference must be implemented to allow inputting one or more belief vector and to output a resulting belief vector. By way of example, as shown in the equations below, belief is denoted as ‘Bel’ and is a function of goal ‘A’ or strategy ‘R’ i.e. Bel(A) and Bel(R). Disbelief, denoted as ‘Del’, is a function of goal ‘A’ i.e. Dis(A). Uncertainty, denoted as ‘Unc’ is a function of goal ‘A’ i.e. Unc(A):

The rule of inference for an alternative strategy may be implemented by using the following equation:

Bel(A)=Bel(R)·(Bel(A₁)·Bel(A₂)+Bel(A₁)·Unc(A₂)+Bel(A₂)·Unc(A₁));

Dis(A)=Dis(R)·(Dis(A₁)·Dis(A₂)+Dis(A₁)·Unc(A₂)+Dis(A₁)·Unc(A₁));

Unc(A)=1−Bel(A)−Dis(A); (3)
where
A=Top goal
A₁=Secondary goal 1
A₂=Secondary goal 2

In embodiments having more than two secondary goals, the calculation using the alternative strategy rule is instead, done via averaging by way of a concepts such as weighting.

As another example of rule of inference, a rule for a complementary strategy for n nodes is shown in the equations below:

$$Bel ( A ) = Bel ( R ) \cdot \frac{{\sum }_{i = 1}^{i = n} ( {W}_{i} \cdot Bel ( {A}_{i} ) )}{{\sum }_{i = 1}^{i = n} {W}_{i}} ; \\ Dis ( A ) = Bel ( R ) \cdot \frac{{\sum }_{i = 1}^{i = n} ( {W}_{i} \cdot Dis ( {A}_{i} ) )}{{\sum }_{i = 1}^{i = n} {W}_{i}} ; \\ Unc ( A ) = 1 - Bel ( R ) \cdot \frac{{\sum }_{i = 1}^{i = n} ( {W}_{i} \cdot ( 1 - Unc ( {A}_{i} ) ) )}{{\sum }_{i = 1}^{i = n} {W}_{i}} ; \\ where \\ A = Top goal \\ {A}_{i} = Secondary goals \\ {W}_{i} = Weight of goals \qquad ( 4 )$$

As further example, a rule of inference for determining a necessary and sufficient strategy of n nodes is expressed by the equations below:

$$Bel ( A ) = Bel ( R ) \cdot {\prod }_{i = 1}^{i = n} Bel ( {A}_{i} ) ; \\ Dis ( A ) = Bel ( R ) \cdot ( 1 - {\prod }_{i = 1}^{i = n} ( 1 - Dis ( {A}_{i} ) ) ) ; \\ Unc ( A ) = 1 - Bel ( A ) - Dis ( A ) ; \\ where \\ A = Top goal \\ {A}_{i} = Secondary goals \qquad ( 5 )$$

As further example, a rule for determining a sufficient strategy for n nodes is expressed by the equations below:

$$Bel ( A ) = Bel ( R ) \cdot {\prod }_{i = 1}^{i = n} Bel ( {A}_{i} ) ; \\ Dis ( A ) = 0 ; \\ Unc ( A ) = 1 - Bel ( A ) ; \\ where \\ A = Top goal \\ {A}_{i} = Secondary goals \qquad ( 6 )$$

A further rule of inference for the counter strategy of negation is expressed by the equations below:

Bel(A)=Dis(Cₛₜᵣ);

Dis(A)=Bel(Cₛₜᵣ);

Unc(A)=1−Bel(A)−Dis(A); (7)
where
A=Top goal
Cₛₜᵣ=Counter strategy

Understandably, any other rules of inference known in the art or deriving from the above presented rules may be implemented in the present method 140 without departing from the present invention.

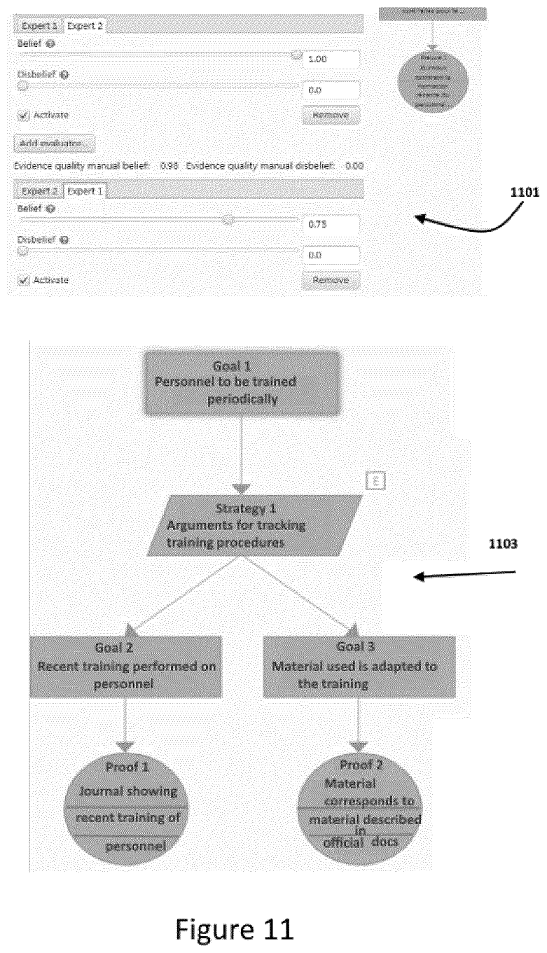

Now referring to FIG. 11, user interfaces of a system for implementing the present invention are shown. The interfaces comprise a user interface 1101 for entry of inputs (belief and disbelief) from Expert 1 and Expert 2. The user interface also provides a graphical view of the argumentative structure being constructed 1103.

Now referring to FIGS. 12 to 17, exemplary screenshots of the interface provided by a probabilistic based system for decision making in the context of argumentative structures are shown.

Referring now to FIG. 12, the interface provides a argumentative structure designer. The system is configured to provide a user tools to add one or more goal (G-1, G2 and G3), evidence (EV-1 and EV-2) and strategy nodes (STR-1 and STR-2) in an argumentative structure. The system further allows linking the nodes of the argumentative structure between each other. Understandably, any other argumentative structure designer tool could be used without departing from the present invention.

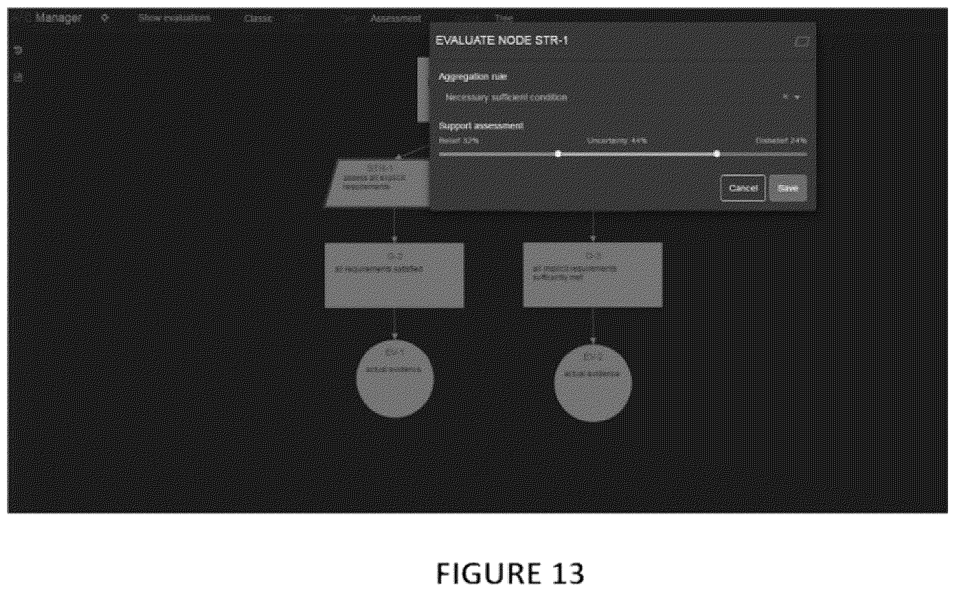

Now referring to FIG. 13, a user may evaluate a node of the argumentative structure. As an example, an interface providing different colors associated to the belief (green), the uncertainty (yellow) and the disbelief (red) is provided. In this example, a strategy node (STR-1) is evaluated; however, any other node could be evaluated. Furthermore, a condition or aggregation rule may be assigned to the node. In this example, a “Necessary sufficient condition” is associated with the said strategy node.

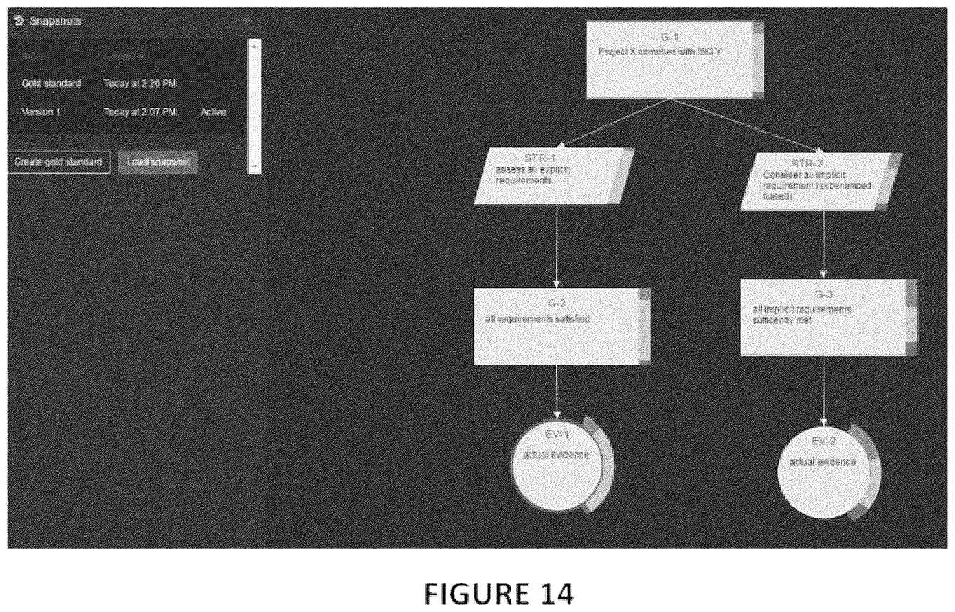

No referring to FIG. 14, the system provides an interface for graphically displaying the evaluation of each nodded in term of the opinion vector (belief, uncertainty, disbelief). As an example, the color of each component of the opinion vector is proportionally displayed about each evaluated node. Such representation allows one to easily assess the evaluation of each node.

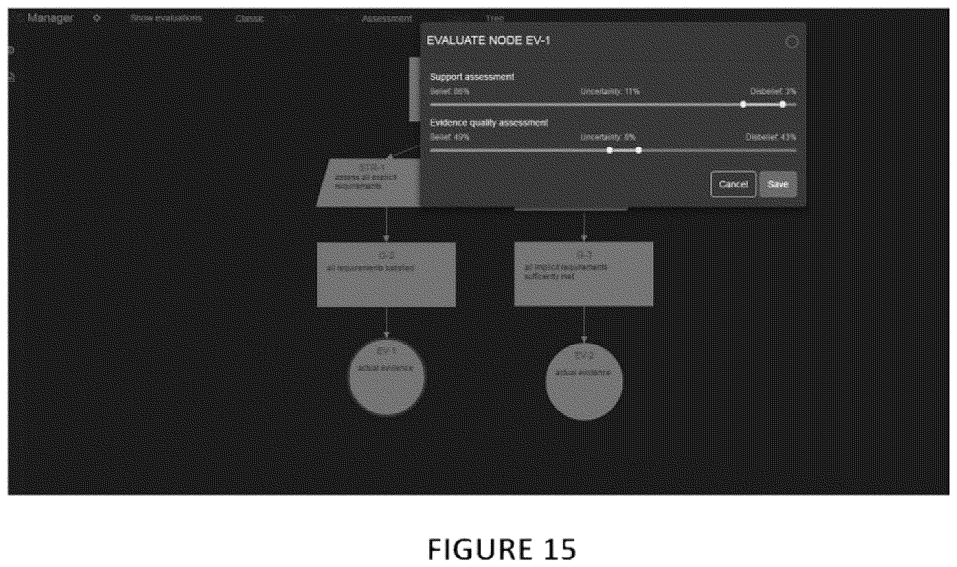

Referring now to FIG. 15, an evidence node is assessed for support and quality.

Again, as an example, the associated belief, uncertainty and disbelief are displayed as a proportion of different colors (green, yellow and red).

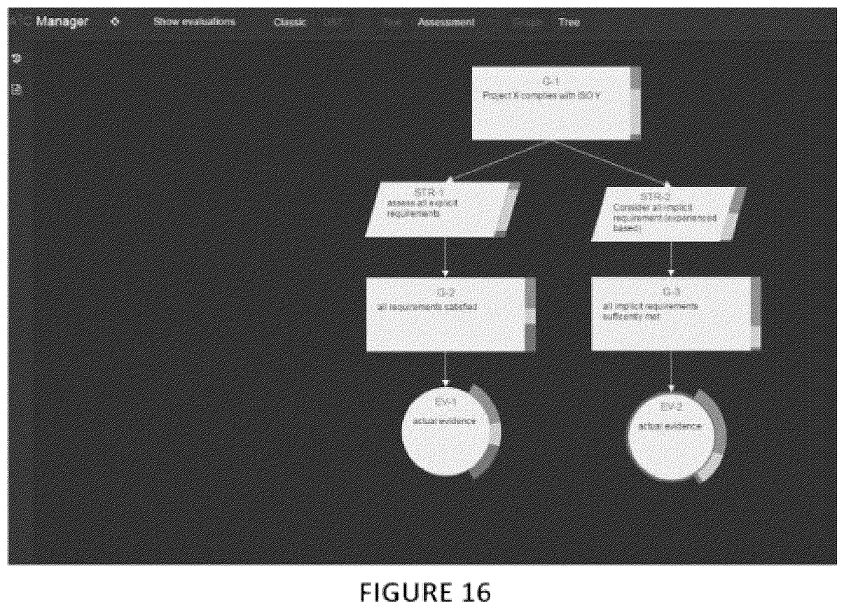

The FIG. 16 shows an example of the interface with the argumentative structure being fully evaluated in view of the opinion of the expert. The colors associated to belief, uncertainty and disbelief are proportionally displayed about each evaluated node. Such representation allows one to easily assess the evaluation of each node.

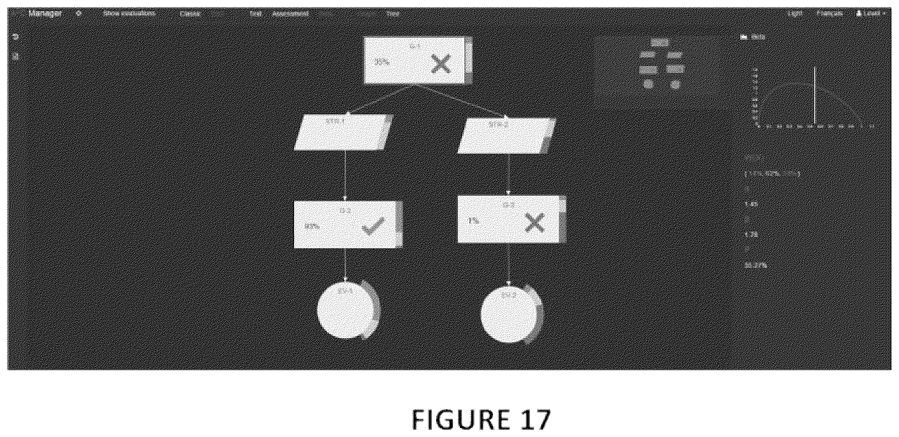

FIG. 17 shows the evaluated argumentative structure being displayed to help in making a decision by providing visual representation of goals having a probability being superior to the predefined Gold standard and of nodes not reaching that level of assessment.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A computer-implemented method for evaluating an argumentative structure to theoretically analyze and determine a desired standard with which a construction of the theoretical argumentative structure is to represent, the method comprising:
a) constructing a theoretical argumentative structure;
b) organizing the theoretical argumentative structure as a tree structure, the tree structure comprising nodes, the nodes being a selection of at least one top goal, at least one strategy, at least one secondary goal, or at least one associated proof;
c) identifying a plurality of inference computational rule between the nodes to finalize the theoretical argumentative structure;
d) evaluating the probative value of the proof nodes of the finalized theoretical argumentative structure using an opinion vector to create an evaluated theoretical argumentative structure being the minimum level to be obtained;
e) combining the evaluated probative values using a mathematical model of Beta distributions;
f) computing a probability of success of a top goal using all evaluation values of each node to by iteratively using the opinion vector as input to each inference computational rule to obtain a faith level for each node, the faith level of the top goal being the Gold standard.

2) The computer-implemented method of claim 1, further comprising obtaining evaluations of the theoretical argumentative structure from at least two experts.

3) The computer-implemented method of claim 2, wherein the experts are specialized or trained in the compliance of the standard or goal aimed to be achieved by the theoretical argumentative structure.

4) The computer-implemented method of claim 3, further comprising modifying the theoretical argumentative structure based on the obtained evaluations.

5) The computer-implemented method of any of claims 1 to 4, the method further comprising:
a) providing a comparable argumentative structure similar in structure to the theoretical argumentative structure;
b) evaluating the proof nodes of comparable argumentative structure in term of validity of the proof by providing at least one vector of belief for each node;
c) comparing the evaluated comparable argumentative structure against the Gold Standard.

6) The computer-implemented method of claim 5, the method further comprising:
a) providing a concrete evaluation of all elements of the comparable argumentative structure to provide a practical argumentative structure;
b) propagating of the evaluations and the associated values throughout the nodes of the practical argumentative structure;
c) rendering a quantitative evaluation of the top nodes of the practical argumentative structure to calculate a final quantitative evaluation of the top goal;
d) calculating a probability of success using a probabilistic distribution.

7) The computer-implemented method of claim 6, wherein the probabilistic distribution is a Beta distribution.

8) The computer-implemented method of claim 7, wherein the Beta distribution is based on Dempster-Shafer model.

9) The computer-implemented method of any of claims 5 to 8, wherein the comparable argumentative structure is reviewed by at least one expert to validate and/or modify the comparable argumentative structure.

10) The computer-implemented method of any of claims 1 to 9, wherein the opinion vector comprises values of belief, disbelief and uncertainty.

11) The computer-implemented method of claim 10, wherein the opinion vector further comprises an atomicity value.

12) The computer-implemented method of any of claim 10 or 11, wherein the belief, disbelief and uncertainty values ranges between 0 and 1.

13) The computer-implemented method of any one of claims 1 to 12, the method further comprising adding a space vector to evaluate the theoretical argument structure.

14) The computer-implemented method of any of claims 1 to 13, wherein a final quantitative value is calculated based on quantitative values assigned to each node of the theoretical argument structure.

15) The computer-implemented method of claim 14, wherein the final quantitative value is an interval in which probability of success for achieving one of the top goal nodes lies, the interval comprising a compliance to selected target laws, norms or standards.

16) A computer-implemented method for decision making based on a modified version of the Goal Structuring Notation (GSN) for argumentative structures comprising goals, the method comprising:
a) setting a Gold standard or reference standard for a reference argumentative structure;
b) calculating a minimum level of success probability for the reference argumentative structure using a probabilistic model mapping a Gold standard;

17) The computer-implemented method of claim 16, wherein the Gold Standard is the minimum level of Faith or Esperance needed to expect that one or more goals are fulfilled.

18) The computer-implemented method of claim 17, wherein the minimum level of Faith or Esperance is calculated using the equation E (Goal1)=b+au.

19) The computer-implemented method of any of claims 16 to 18, the method further comprising using an opinion vector associated with a top goal of the argumentative structure to be evaluated to calculate the probabilistic distribution.

20) The computer-implemented method of any of claim 17 or 18, the method further comprising calculating probability that the Esperance associated with a top goal of the argumentative structure to be evaluated is higher than the Esperance of the established Gold standard.

21) The computer-implemented method of claim 20, the method further comprising satisfying the structure or affirmation when the calculated probability is higher than a predetermined value.

22) The computer-implemented method of claim 21, wherein the predetermined value is set by experts having evaluated the nodes of the argumentative structure.

23) The computer-implemented method of claim 22, the method further comprising making a decision based on the context of an affirmation of the top goal and/or of a field of application.

24) The computer-implemented method of any one of claims 16 to 23, the method further comprising creating relationships between the nodes of the argumentative structure.

25) The computer-implemented method of claim 24, the nodes comprising goal nodes, strategy nodes and proof nodes.

26) The computer-implemented method of any of claim 24 or 25, the method further comprising linking the nodes of resulting structure with the relationships establishing theoretical conditions of fulfillment of said goal or strategies.

27) The computer-implemented method of claim 25, the method further comprising using formal proofs as a validation of a strategy node and a goal node being in relation with the said strategy node.

28) The computer-implemented method of any claim 25 or 27, wherein the proof nodes are evaluated in terms of validity of the proof to compare the structure against the Gold Standard.
